(19) United States
(12) Patent Application Publication
(10) Pub. No.: US 2020/0349391 A1
(43) Pub. Date: Nov. 5, 2020

(54) METHOD FOR TRAINING IMAGE GENERATION NETWORK, ELECTRONIC DEVICE, AND STORAGE MEDIUM

(71) Applicant: SHENZHEN SENSETIME TECHNOLOGY CO., LTD., Shenzhen (CN)

(72) Inventors: Yu ZHANG, Shenzhen (CN); Dongqing Zou, Shenzhen (CN); Sijie Ren, Shenzhen (CN); Zhe Jiang, Shenzhen (CN); Xiaohao Chen, Shenzhen (CN)

(21) Appl. No.: 16/857,337

(22) Filed: Apr. 24, 2020

Related U.S. Application Data
(63) Continuation of application No. PCT/CN2019/101457, filed on Aug. 19, 2019.

(30) Foreign Application Priority Data
Apr. 30, 2019 (CN) 201910363957.5

(51) Int. Cl. G06K 9/62; G06N 3/08

(52) U.S. Cl. CPC G06K 9/6257; G06K 9/6263; G06N 3/08; G06K 9/6255

(57) ABSTRACT

A method for training an image generation network, an electronic device and a storage medium are provided. The method includes: obtaining a sample image, where the sample image includes a first sample image and a second sample image corresponding to the first sample image; processing the first sample image based on an image generation network to obtain a predicted target image; determining a difference loss between the predicted target image and the second sample image; and training the image generation network based on the difference loss to obtain a trained image generation network.

### CROSS-REFERENCE TO RELATED APPLICATIONS

This application is a continuation of International Patent Application No. PCT/CN2019/101457, filed on Aug. 19, 2019, which claims priority to Chinese Patent Application No. 201910363957.5, filed on Apr. 30, 2019. The disclosures of International Patent Application No. PCT/CN2019/101457 and Chinese Patent Application No. 201910363957.5 are hereby incorporated by reference in their entireties.

### BACKGROUND

The conversion of 2D (2 dimensions) to a 3D (3 dimensions) stereo effect needs to restore the scene content captured at another viewpoint according to an input monocular image. In order to form a 3D hierarchical look and feel, in this process, it is required to understand the depth information of the input scene, and based on a binocular disparity relationship, translate input left-view pixels according to the disparity to generate right-view content. A conventional manual making process usually involves procedures such as deep reconstruction, hierarchical segmentation, and filling of void regions, and thus, the process is time-consuming and requires much effort. With the rise of the field of artificial intelligence, the academic community proposes to use convolutional neural networks to model an image synthesis process based on binocular disparity, and automatically learn a correct parallax relationship by means of training based on a large amount of stereo image data. During a training process, it is required to translate a left-view image through the disparity, and a generated right-view image has the same color value as a real right-view image. However, in practical applications, the content of the right-view image generated in this manner often suffers from structural loss and object deformation, which seriously affects the quality of the generated image.

### SUMMARY

The present disclosure relates to image processing technologies, and in particular, to a method for training an image generation network, an electronic device, and a storage medium.

Embodiments of the present disclosure provide technical solutions for training an image generation network and image processing.

According to a first aspect of the embodiments of the present disclosure, provided is a method for training an image generation network, including: obtaining a sample image, where the sample image includes a first sample image and a second sample image corresponding to the first sample image; processing the first sample image based on an image generation network to obtain a predicted target image; determining a difference loss between the predicted target image and the second sample image; and training the image generation network based on the difference loss to obtain a trained image generation network.

According to a second aspect of the embodiments of the present disclosure, provided is an electronic device, including: a processor, and a memory configured to store processor-executable instructions, where the processor is configured to execute the instructions to implement the method for training an image generation network according to the first aspect of the present disclosure.

According to a third aspect of the embodiments of the present disclosure, provided is a computer storage medium, configured to store computer-readable instructions, where the readable instructions, when being executed, cause to perform operations of the method for training an image generation network according to the first aspect of the present disclosure.

Based on the method and apparatus for training an image generation network, the method and apparatus for image processing, and the electronic device provided in the foregoing embodiments of the present disclosure, a sample image is obtained, where the sample image includes a first sample image and a second sample image corresponding to the first sample; the first sample image is processed based on an image generation network to obtain a predicted target image; a difference loss between the predicted target image and the second sample image is determined; and the image generation network is trained based on the difference loss to obtain a trained image generation network. A structural difference between the predicted target image and the second sample image is described through the difference loss, and the image generation network is trained based on the difference loss, thereby ensuring an undistorted structure of an image generated based on the image generation network.

It should be understood that the above general description and the following detailed description are merely exemplary and explanatory, and are not intended to limit the present disclosure.

The other features and aspects of the present disclosure can be described more clearly according to the following detailed descriptions of the exemplary embodiments in the accompanying drawings.

### BRIEF DESCRIPTION OF DRAWINGS

The accompanying drawings constituting a part of the specification describe the embodiments of the present disclosure and are intended to explain the principles of the present disclosure together with the descriptions.

According to the following detailed descriptions, the present disclosure can be understood more clearly with reference to the accompanying drawings.

FIG. 1 is a schematic flowchart of a method for training an image generation network provided in embodiments of the present disclosure;

FIG. 2 is another schematic flowchart of a method for training an image generation network provided in embodiments of the present disclosure;

FIG. 3 is still another partial schematic flowchart of a method for training an image generation network provided in embodiments of the present disclosure;

FIG. 4 is a schematic diagram of a network structure involved in a method for training an image generation network provided in embodiments of the present disclosure;

FIG. 5 is a schematic flowchart of a method for image processing provided in embodiments of the present disclosure;

FIG. 6 is a schematic structural diagram of an apparatus for training an image generation network provided in embodiments of the present disclosure;

FIG. 7 is a schematic structural diagram of an apparatus for image processing provided in embodiments of the present disclosure; and

FIG. 8 is a schematic structural diagram of an electronic device suitable for implementing a terminal device or a server according to embodiments of the present disclosure.

### DETAILED DESCRIPTION

The various exemplary embodiments, features, and aspects of the present disclosure are described below in detail with reference to the accompanying drawings. The same signs in the accompanying drawings represent elements having the same or similar functions. Although the various aspects of the embodiments are illustrated in the accompanying drawings, unless stated particularly, it is not required to draw the accompanying drawings in proportion.

Various exemplary embodiments of the present disclosure are now described in detail with reference to the accompanying drawings. It should be noted that, unless otherwise stated specifically, relative arrangement of the components and steps, the numerical expressions, and the values set forth in the embodiments are not intended to limit the scope of the present disclosure.

In addition, it should be understood that, for ease of description, the size of each part shown in the accompanying drawings is not drawn in actual proportion.

The following descriptions of at least one exemplary embodiment are merely illustrative actually, and are not intended to limit the present disclosure and the applications or uses thereof.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

In recent years, the popularity of media, such as 3D stereo movies, advertisements, and live broadcast platforms, has greatly enriched people's daily lives, and its industry scale has continued to expand. However, in contrast to the high popularity rate and high occupancy ratio of 3D display hardware on the market, stereo image and video content is deficient in existing quantity due to high expenses, a long production cycle, and a lot of labor costs during production of the stereo image and video content. In contrast, 2D image and video materials have formed a considerable scale, and rich and valuable information have been accumulated in the fields such as film and television entertainment, culture and art, and scientific research. If these 2D images and videos can be converted into high-quality stereo images and videos in an automatic and low-cost manner, it will create a new user experience and has a broad market application prospect.

The conversion of 2D to a 3D stereo effect needs to restore the scene content captured at another viewpoint according to an input monocular image. In order to form a 3D hierarchical look and feel, in this process, it is required to understand the depth information of the input scene, and based on a binocular disparity relationship, translate input left-view pixels according to the disparity to generate right-view content. A common method for converting 2D to 3D stereo only generates an average color difference between a generated right-view image and a real right-view image as a training signal by means of comparison, it is susceptible to environmental factors such as lighting, blocking, and noise, and it is difficult to maintain the accuracy of synthesis of an object with a small visual area, resulting in a synthesis result with large deformation and loss of details. However, an existing method for generating an image with a shape remained mainly introduces the supervision signal of a three-dimensional world, so that a network learns correct cross-view transformation, thereby maintaining the consistency of the shape at different views. However, due to special application conditions of introduced 3D information, the generalization ability of a model is limited and it is difficult to play a role in actual industrial fields.

In view of the above problems occurring in the process of converting 2D to a 3D stereo effect, embodiments of the present disclosure provide the following method for training an image generation network. The image generation network obtained by means of the training method according to the embodiments of the present disclosure can output the scene content captured at another viewpoint based on a monocular image input into the image generation network, thereby implementing the conversion of 2D to a 3D stereo effect.

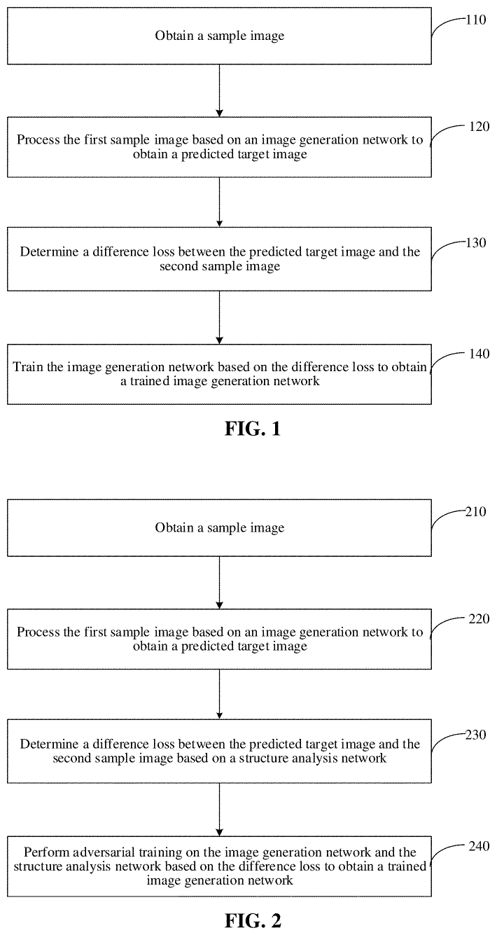

FIG. 1 is a schematic flowchart of a method for training an image generation network provided in embodiments of the present disclosure. As shown in FIG. 1, the method according to the embodiments includes the following steps.

At block 110, a sample image is obtained.

The sample image includes a first sample image and a second sample image corresponding to the first sample image.

The execution subject of the method for training an image generation network in the embodiments of the present disclosure may be a terminal device or a server or another information processing device, where the terminal device may be a User Equipment (UE), a mobile device, a user terminal, a terminal, a cellular phone, a cordless phone, a Personal Digital Assistant (PDA), a handheld device, a computing device, a vehicle-mounted device, a wearable device, or the like. In some possible implementations, the method for training an image generation network may be implemented by a processor by invoking computer-readable instructions stored in a memory.

An image frame may be a single frame of image, and may be an image acquired by an image acquisition device, for example, a photo captured by a camera of a terminal device, or a single frame of image in video data acquired by video data acquired by a video acquisition device, etc. Specific implementation is not limited in the embodiments of the present disclosure.

As one implementation, the second sample image may be a real image, and may be used as reference information for measuring the performance of an image generation network in the embodiments of the present disclosure. The goal of the image generation network is to make an obtained predicted target image closer to the second sample image. The obtaining of the sample image can be selected from an image library with a known correspondence or captured according to actual requirements.

At block 120, the first sample image is processed based on an image generation network to obtain a predicted target image.

As one implementation, the image generation network provided in the embodiments of the present disclosure may be applied to functions such as 3D image synthesis, and the image generation network may use any stereo image generation network, for example, a deep 3D network proposed by Xie et al. of the University of Washington in 2016, etc.; while for other image generation applications, the image generation network can be replaced accordingly, and it is only necessary to ensure that the image generation network can end-to-end synthesize the target image based on the input sample image.

At block 130, a difference loss between the predicted target image and the second sample image is determined.

The embodiments of the present disclosure propose describing a difference between the predicted target image obtained by the image generation network and the second sample image with the difference loss. Therefore, the image generation network is trained based on the difference loss, so as to increase a similarity between the generated predicted target image and the second sample image, thereby improving the performance of the image generation network.

At block 140, the image generation network is trained based on the difference loss to obtain a trained image generation network.

Based on the method for training an image generation network provided in the foregoing embodiments of the present disclosure, a sample image is obtained, where the sample image includes a first sample image and a second sample image corresponding to the first sample; the first sample image is processed based on an image generation network to obtain a predicted target image; a difference loss between the predicted target image and the second sample image is determined; and the image generation network is trained based on the difference loss to obtain a trained image generation network. A structural difference between the predicted target image and the second sample image is described through the difference loss, and the image generation network is trained based on the difference loss, thereby ensuring an undistorted structure of an image generated based on the image generation network.

FIG. 2 is another schematic flowchart of a method for training an image generation network provided in embodiments of the present disclosure. As shown in FIG. 2, the embodiments of the present disclosure include the following steps.

At block 210, a sample image is obtained.

The sample image includes a first sample image and a second sample image corresponding to the first sample image.

At block 220, the first sample image is processed based on an image generation network to obtain a predicted target image.

At block 230, a difference loss between the predicted target image and the second sample image is determined based on a structure analysis network.

In one embodiment, the structure analysis network can extract three layers of features, that is, an encoder included several layers of Convolutional Neural Networks (CNN). Optionally, the structure analysis network in the implementation of the present disclosure includes an encoder and a decoder. The encoder takes one image (the predicted target image or the second sample image in the embodiments of the present disclosure) as an input, and obtains a series of feature maps of different scales. For example, it includes several layers of CNNs. The decoder takes these feature maps as an input and reconstructs the input image itself. Network structures that satisfy the above requirements can be used as structure analysis networks.

As reference information for adversarial training, the difference loss is determined based on structural features. For example, the difference loss is determined through a difference between the structural feature of the predicted target image and the structural feature of the second sample image. It can be considered that the structural features provided in the embodiments of the present disclosure are a normalized correlation between a local area centered on one position and its surrounding region.

As an optional implementation, the embodiments of the present disclosure may use a UNet structure. The encoder of this structure includes three convolutional modules, and each module includes two convolutional layers and one average pooling layer. Therefore, after passing through a convolutional module, the resolution becomes half, and feature maps with a size of ½, ¼, and ⅛ of the original image size are finally obtained. The decoder includes the same three up-sampling layers. Each layer up-samples the output from the previous layer and then passes through two convolutional layers. The output from the last layer is the original resolution.

At block 240, adversarial training is performed on the image generation network and the structure analysis network based on the difference loss to obtain a trained image generation network.

As an optional implementation, during a training phase, adversarial training is performed on the image generation network and the structure analysis network, and the input image passes through the image generation network. For example, during application to 3D image generation, an image at one viewpoint is input into the image generation network to obtain a generated image of this image at another viewpoint. The generated image is input into the same structure analysis network as a real image at this viewpoint, and respective multi-scale feature maps are obtained. On each scale, respective feature correlation expressions are calculated as structural representations on this scale. A training process is performed in an adversarial manner. The structure analysis network is required to continuously enlarge a distance between the structural representations of the generated image and that of the real image. At the same time, the generated image obtained by the image generation network is required to make the distance as small as possible.

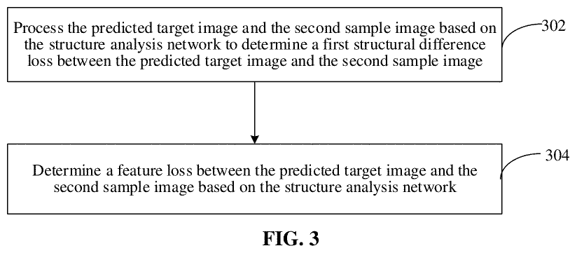

FIG. 3 is still another partial schematic flowchart of a method for training an image generation network provided in embodiments of the present disclosure. In the embodiments, the difference loss includes a first structural difference loss and a feature loss.

The operation of block 130 and/or block 230 in the embodiments shown in FIG. 1 and/or FIG. 2 includes the following steps.

At block 302, the predicted target image and the second sample image are processed based on the structure analysis network to determine a first structural difference loss between the predicted target image and the second sample image.

At block 304, a feature loss between the predicted target image and the second sample image is determined based on the structure analysis network.

In the embodiments of the present disclosure, feature maps of multiple scales and a structural feature of each position in a feature map of each scale can be obtained respectively by processing the target image and the second sample image (for example, the real image corresponding to the first sample image) via the structure analysis network, the first structural difference loss is determined based on a structural feature of each position in multiple feature maps corresponding to the target image, and a structural feature of each position in multiple feature maps corresponding to the second sample image; while the feature loss is determined based on the each position in the multiple feature maps corresponding to the predicted target image and the each position in the multiple feature maps corresponding to the second sample image.

As one implementation, the operation of block 302 includes: processing the predicted target image based on the structure analysis network to determine at least one first structural feature of at least one position in the predicted target image; processing the second sample image based on the structure analysis network to determine at least one second structural feature of at least one position in the second sample image; and determining the first structural difference loss between the predicted target image and the second sample image based on the at least one first structural feature and the at least one second structural feature.

In the embodiments of the present disclosure, the predicted target image and the second sample image are processed respectively via the structure analysis network, for the predicted target image, at least one feature map is obtained, and for each position in each feature map, one first structural feature is obtained, i.e., at least one first structural feature is obtained; and for the second sample image, at least one second structural feature is also obtained. The first structural difference loss in the embodiments of the present disclosure is obtained by collecting statistics about a difference between the first structural feature of the target image corresponding to each position in each scale and the second structural feature of the second sample, i.e., a structural difference between the first structural feature and the second structural feature corresponding to a same position in each scale is calculated respectively, so as to determine the structural difference loss between two images.

For example, in one example, the embodiments of the present disclosure are applied to training of a 3D image generation network. That is, the image generation network generates a right-view image (corresponding to a target image) based on a left-view image (corresponding to a sample image). It is assumed that the input left-view image is x, the generated right-view image is y, and the real right-view image is y_{g}.

Calculation can be performed through the following formula (1):

$${d}_{s} ( y , {y}_{g} ) = \frac{1}{\vert P \vert} {Σ}_{p ∈ P} {‖ c ( p ) - {c}_{g} ( p ) ‖}_{1} \qquad ( 1 )$$

dₛ(y,y_{g}) represents the first structural difference loss, c(p) represents a first structural feature of a generated right-view image y at a position p in the feature map in one scale, c_{g}(p) represents a second structural feature in a real right-view image y_{g} at the position p in the feature map in one scale, P represents all positions in the feature map in all scales, and ∥c(p)−c_{g}(p)∥₁ represents a distance L₁ between c(p) and c_{g}(p).

During the training phase, the structure analysis network looks for a feature space so that the structural distance represented by the above formula can be maximized.

At the same time, the image generation network makes the structure analysis network difficult to distinguish a difference between the two by generating a right-view image that has a structure similar to that of the real right-view image as much as possible. By means of adversarial training, structural differences at different hierarchies can be found and continuously used to modify the image generation network.

As one implementation, processing the predicted target image based on the structure analysis network to determine the at least one first structural feature of the at least one position in the predicted target image includes: processing the predicted target image based on the structure analysis network to obtain a first feature map in at least one scale of the predicted target image; and for each first feature map, obtaining the at least one first structural feature of the predicted target image based on a cosine distance between a feature of each of at least one position in the first feature map and an adjacent region feature of the position.

Each position in the first feature map corresponds to one first structural feature, and the adjacent region feature is each feature in a region centered on the position and including at least two positions.

As one implementation, the adjacent region feature in the embodiments of the present disclosure may be expressed as each feature in a region with a size of K*K centered on each position feature.

In one optional example, the embodiments of the present disclosure are applied to training of a 3D image generation network. That is, the image generation network generates a right-view image (corresponding to a target image) based on a left-view image (corresponding to a sample image). It is assumed that the input left-view image is x, the generated right-view image is y, and the real right-view image is y_{g}·y and y_{g} are input into the structure analysis network respectively to obtain multi-scale features. The following takes only a certain scale as an example, and the processing methods for other scales are similar. It is assumed that on this scale, the feature maps of the generated right-view image and the real right-view map are f and f_{g} respectively. For a certain pixel position p on the feature map of the generated right-view image, f (p) represents a feature of this position. Then on this scale, the first structural feature of the position p can be implemented based on the following formula (2):

$$c ( p ) = vec ( {\{ \frac{{f ( p )}^{T} f ( q )}{{‖ f ( p ) ‖}_{2} {‖ f ( q ) ‖}_{2}} \}}_{q ∈ {⋰}_{k} ( p )} ) \qquad ( 2 )$$

q∈□ [symbol] (p)represents a position set in a region with a size of k×k centered on the position p, q is one position in the position set, f(q) is a feature of the position q, ∥⋅∥₂ is a norm of a vector, and vec represents vectorization. In the above formula, a cosine distance between the position p on the feature map and its surrounding neighboring position is calculated. Optionally, in the embodiments of the present disclosure, a window size k may be set to 3.

As one implementation, processing the second sample image based on the structure analysis network to determine the at least one second structural feature of the at least one position in the second sample image includes: processing the second sample image based on the structure analysis network to obtain a second feature map in at least one scale of the second sample image; and for each second feature map, obtaining the at least one second structural feature of the second sample image based on a cosine distance between a feature of each of at least one position in the second feature map and an adjacent region feature of the position.

Each position in the second feature map corresponds to one second structural feature.

In one optional example, the embodiments of the present disclosure are applied to training of a 3D image generation network. That is, the image generation network generates a right-view image (corresponding to the predicted target image) based on a left-view image (corresponding to the first sample image). It is assumed that the input left-view image is x, the generated right-view image is y, and the real right-view image is y_{g}·y and y_{g} are input into the structure analysis network respectively to obtain multi-scale features. The following takes only a certain scale as an example, and the processing methods for other scales are similar. It is assumed that on this scale, the feature maps of the generated right-view image and the real right-view map are f and f_{g} respectively. For a certain pixel position p on the feature map of the real right-view image, f_{g}(q) represents a feature of this position. Then on this scale, the second structural feature of the position p can be implemented based on the following formula (3):

$${c}_{g} ( p ) = vec ( {\{ \frac{{{f}_{g} ( p )}^{T} {f}_{g} ( q )}{{‖ {f}_{g} ( p ) ‖}_{2} {‖ {f}_{g} ( q ) ‖}_{2}} \}}_{q ∈ {⋰}_{k} ( p )} ) \qquad ( 3 )$$

q∈ [symbol] (p) represents a position set in a region with a size of k×k centered on the position p, q is one position in the position set, f_{g}(q) is a feature of the position q, ∥⋅∥₂ is a norm of a vector, and vec represents vectorization. In the above formula, a cosine distance between the position p on the feature map and its surrounding neighboring position is calculated. Optionally, in the embodiments of the present disclosure, a window size k may be set to 3.

As one implementation, a correspondence exists between the each position in the first feature map and the each position in the second feature map; determining the first structural difference loss between the predicted target image and the second sample image based on the at least one first structural feature and the at least one second structural feature includes: calculating a distance between the first structural feature and the second structural feature corresponding to positions where the correspondence exists; and determining the first structural difference loss between the predicted target image and the second sample image based on distances between all first structural features and second structural features corresponding to the predicted target image.

For the process of obtaining the first structural difference loss by means of calculation in the embodiments of the present disclosure, refer to the formula (1) in the foregoing embodiments. Based on the formula (2) and formula (3) in the foregoing embodiments, the first structural feature c(p) in the target image y at the position p in the feature image in one scale and the second structural feature c_{g}(p) in the real image y_{g} at the position p in the feature map in one scale can be obtained respectively. The distance between the first structural feature and the second structural feature may be the distance L₁.

In one or more optional embodiments, the operation of block 304 includes: processing the predicted target image and the second sample image based on the structure analysis network to obtain a first feature map in at least one scale of the predicted target image and a second feature map in at least one scale of the second sample image; and determining the feature loss between the predicted target image and the second sample image based on at least one first feature map and at least one second feature map.

The feature loss in the embodiments of the present disclosure is determined based on a difference between corresponding feature maps obtained based on the predicted target image and the second sample image, and this is different from the manner of obtaining the first structural difference loss based on structure features in the foregoing embodiments. Optionally, the correspondence exists between the each position in the first feature map and the each position in the second feature map; determining the feature loss between the predicted target image and the second sample image based on the at least one first feature map and the at least one second feature map includes: calculating a distance between a feature in the first feature map and a feature in the second feature map corresponding to the positions where the correspondence exists; and determining the feature loss between the predicted target image and the second sample image based on the feature in the first feature map and the feature in the second feature map.

In one optional embodiment, a distance L₁ between the feature in the first feature map and the feature in the second feature map corresponding to each position is calculated, and the feature loss is determined through the distance L₁. Optionally, it is assumed that the predicted target image is y and the second sample image is y_{g}·y and y_{g} are input into the structure analysis network respectively to obtain multi-scale features. The following takes only a certain scale as an example, and the processing methods for other scales are similar. On this scale, the feature maps of the predicted target image and the second sample image are f and f_{g} respectively. For a certain pixel position p on the feature map of the second sample image, f_{g}(p) represents a feature of this position. In this case, the feature loss can be obtained based on the following formula (4):

$${d}_{f} ( y , {y}_{g} ) = \frac{1}{\vert P \vert} {Σ}_{p ∈ P} {‖ f ( p ) - {f}_{g} ( p ) ‖}_{1} \qquad ( 4 )$$

d_{f}(y,y_{g}) represents the feature loss between the predicted target image and the second sample image, and f(p) is a feature at a position p in the first feature map, and f_{g}(p) represents a feature at a position p in the second feature map.

As one implementation, the difference loss may further include a color loss. Before executing the operation of block 240, the method further includes: determining a color loss of the image generation network based on the color loss between the predicted target image and the second sample image.

In the embodiments of the present disclosure, the color difference between the predicted target image and the second sample image is reflected through the color loss, so that the color of the predicted target image can be close to that of the second sample image as much as possible. Optionally, it is assumed that the predicted target image is y and the second sample image is y_{g}. The color loss can be obtained based on the following formula (5):

dₐ(y,y_{g})=∥y−y_{g}∥₁ (5)

dₐ(y,y_{g}) represents the color loss between the predicted target image and the second sample image, and ∥y−y_{g}∥₁ represents a distance L₁ between the predicted target image y and the second sample image y_{g}.

In the present embodiments, the operation of block 240 includes: in a first iteration, adjusting a network parameter in the image generation network based on the first structural difference loss, the feature loss, and the color loss; in a second iteration, adjusting the network parameter in the structure analysis network based on the first structural difference loss; and obtaining a trained image generation network when a training stopping condition is satisfied.

The first iteration and the second iteration are two continuously-executed iterations. Optionally, the training stopping condition may be that a preset number of iterations or a difference between the predicted target image generated by the image generation network and the second sample image is less than a set value, etc. Which training stopping condition is not specifically limited in the embodiments of the present disclosure.

The purpose of the adversarial training is to reduce a difference between the predicted target image obtained by the image generation network and the second sample image. The adversarial training is usually implemented by means of alternating training. In the embodiments of the present disclosure, the image generation network and the structure analysis network are alternately trained to obtain an image generation network that satisfies requirements. Optionally, the adjustment of the network parameter of the image generation network may be performed through the following formula (6):

min_{w}_{_{S}}L_{S}(y,y_{g})=dₐ(y,y_{g})+dₛ(y,y_{g})+d_{f}(y,y_{g}) (6)

w_{S} represents a parameter to be optimized in the image generation network, L_{S}(y,y_{g}) represents an overall loss corresponding to the image generation network, min_{w}_{_{S}}L_{S}(y,y_{g}) represents the overall loss of the image generation network reduced by adjusting the parameter of the image generation network, and dₐ(y,y_{g}), dₛ(y,y_{g}), and d_{f}(y,y_{g}) respectively represent the color loss, first structural difference loss, and feature loss between the predicted target image and the second sample image generated by the image generation network. Optionally, the obtaining of these losses can be determined by referring to the above formulas (5), (1), and (4), or these three losses can be obtained in other manners. The specific manners for obtaining the color loss, the first structural difference loss, and the feature loss are not limited in the embodiments of the present disclosure.

As one implementation, the adjustment of the network parameter of the structure analysis network can be performed through the following formula (7):

max_{w}_{_{A}}L_{A}(y,y_{g})=dₛ(y,y_{g}) (7)

w_{A} represents a parameter to be optimized in the structure analysis network, L_{A}(y,y_{g}) represents an overall loss corresponding to the structure analysis network, max_{w}_{_{A}}L_{A}(y,y_{g}) represents the overall loss of the structure analysis network increased by adjusting the parameter of the structure analysis network, and dₛ(y,y_{g}) represents the first structural difference loss of the structure analysis network. Optionally, the obtaining of the first structural difference loss can be determined by referring to the above formula (1), or obtained in other manners. The specific manner for obtaining the first structural difference loss is not limited in the embodiments of the present disclosure.

In one or more optional embodiments, before determining the structural difference loss between the target image and the real image, the method further includes: adding noise to the second sample image to obtain a noise image; and determining a second structural difference loss based on the noise image and the second sample image.

Because the predicted target image is generated from the sample image, while the second sample image usually has a lighting difference and will be affected by noise, resulting in a certain distribution difference between the generated predicted target image and the second sample image. In order to prevent the structure analysis network from paying attention to these differences, rather than scene structure information, in the embodiments of the present disclosure, a resistance mechanism to noise is added during the training process.

As one implementation, determining the second structural difference loss based on the noise image and the second sample image includes: processing the noise image based on the structure analysis network to determine at least one third structural feature of at least one position in the noise image; processing the second sample image based on the structure analysis network to determine the at least one second structural feature of the at least one position in the second sample image; and determining the second structural difference loss between the noise image and the second sample image based on the at least one third structural feature and the at least one second structural feature.

As one implementation, the noise image is obtained by processing based on the second sample image. For example, artificial noise is added to the second sample image to generate a noise image. There are many manners to add noise. For example, random Gaussian noise is added, Gaussian blurring is performed on the real image (second sample image), contrast is changed, etc. In the embodiments of the present disclosure, it is required that for the noise image obtained after adding noise, only attributes (for example, color, texture, etc.) that do not affect the structure in the second sample image are changed, but the shape structure in the second sample image is not changed. The specific manner for obtaining the noise image is not limited in the embodiments of the present disclosure.

The structure analysis network in the embodiments of the present disclosure takes a color image as an input, and an existing structure analysis network mainly takes a mask image or a gray-scale image as an input. The processing of a high-dimensional signal such as a color image is more susceptible to interference from environmental noise. Therefore, the embodiments of the present disclosure propose to introduce a second structural difference loss to enhance the noise robustness of structural features. The shortcoming that there is no anti-noise mechanism in the adversarial training method with an existing structure is made up.

As one implementation, processing the noise image based on the structure analysis network to determine the at least one third structural feature of the at least one position in the noise image includes: processing the noise image based on the structure analysis network to obtain a third feature map in at least one scale of the noise image; and for each third feature map, obtaining the at least one third structural feature of the noise image based on a cosine distance between a feature of each of at least one position in the third feature map and an adjacent region feature of the position.

Each position in the third feature map corresponds to one third structural feature, and the adjacent region feature is each feature in a region centered on the position and including at least two positions.

In the embodiments of the present disclosure, the manner of determining the third structural feature is similar to that of obtaining the first structural feature. Optionally, in one example, it is assumed that the input first sample image is x, the second sample image is y_{g}, and the noise image is yₙ·yₙ and y_{g} are input into the structure analysis network respectively to obtain multi-scale features. The following takes only a certain scale as an example, and the processing methods for other scales are similar. It is assumed that on this scale, the feature maps of the noise image and the second sample image are fₙ and f_{g} respectively. For a certain pixel position p on the feature map of the noise image, fₙ(p) represents a feature of this position. Then on this scale, the third structural feature of the position p can be implemented based on the following formula (8):

$${c}_{n} ( p ) = vec ( {\{ \frac{{{f}_{n} ( p )}^{T} {f}_{n} ( q )}{{‖ {f}_{n} ( p ) ‖}_{2} {‖ {f}_{n} ( q ) ‖}_{2}} \}}_{q ∈ {⋰}_{k} ( p )} ) \qquad ( 8 )$$

q∈ [symbol] (p) represents a position set in a region with a size of k×k centered on the position p, q is one position in the position set, fₙ(p) is a feature of the position q, ∥⋅∥₂ is a norm of a vector, and vec represents vectorization. In the above formula, a cosine distance between the position p on the feature map and its surrounding neighboring position is calculated. Optionally, in the embodiments of the present disclosure, a window size k may be set to 3.

As one implementation, a correspondence exists between the each position in the third feature map and the each position in the second feature map; determining the second structural difference loss between the noise image and the second sample image based on the at least one third structural feature and the at least one second structural feature includes: calculating a distance between the third structural feature and the second structural feature corresponding to positions where the correspondence exists; and determining the second structural difference loss between the noise image and the second sample image based on distances between all third structural features and second structural features corresponding to the noise image.

In the embodiments of the present disclosure, the process of obtaining the second structural difference loss is similar to the process of obtaining the first structural difference loss, and only the first structural feature of the predicted target image during the obtaining of the first structural difference loss is replaced with the third structural feature of the noise image in the embodiments of the present disclosure. Optionally, the second structural difference loss can be obtained based on the following formula (9):

$${d}_{n} ( {y}_{n} , {y}_{g} ) = \frac{1}{\vert P \vert} {Σ}_{p ∈ P} {‖ {c}_{n} ( p ) - {c}_{g} ( p ) ‖}_{1} \qquad ( 9 )$$

dₙ(yₙ,y_{g})represents the second structural difference loss, cₙ(p) represents the third structural feature of the position p, P represents all positions in the feature map in all scales, c_{g}(p)represents the second structural feature of the position p (which can be obtained based on the above formula (3)), and ∥cₙ(p)−c_{g}(p)∥₁ represents a distance L₁ between cₙ(p) and c_{g}(p).

In one or more optional embodiments, the operation of block 240 includes: in a third iteration, adjusting the network parameter in the image generation network based on the first structural difference loss, the feature loss, and the color loss; in a fourth iteration, adjusting the network parameter in the structure analysis network based on the first structural difference loss and the second structural difference loss; and obtaining the trained image generation network when the training stopping condition is satisfied.

The third iteration and the fourth iteration are two continuously-executed iterations. After the second structural difference loss corresponding to the noise image is obtained, in order to improve the performance of the structure analysis network, the second structural difference loss is added during adjustment of the network parameter of the structure analysis network. In this case, the network parameter of the structure analysis network can be adjusted through the following formula (10):

max_{w}_{_{A}}L_{A}(y,y_{g})=−aₙdₙ(yₙ,y_{g})+dₛ(y,y_{g}) (10)

w_{A} represents a parameter to be optimized in the structure analysis network, L_{A}(y,y_{g},yₙ) represents an overall loss corresponding to the structure analysis network, max_{w}_{_{A}}L_{A}(y,y_{g},yₙ) represents the overall loss of the structure analysis network increased by adjusting the parameter of the structure analysis network, dₛ(y,y_{g}) represents the first structural difference loss of the structure analysis network, and dₙ(yₙ,y_{g}) represents the second structural difference loss of the structure analysis network, and aₙ represents a set constant used for adjusting the proportion of the second structural difference loss in adjustment of the parameter of the structure analysis network. Optionally, the obtaining of the first structural difference loss and the second structural difference loss may be determined respectively by referring to the above formula (1) and formula (9), or obtained in other manners. The specific manner for obtaining the first structural difference loss is not limited in the embodiments of the present disclosure.

In one or more optional embodiments, after processing the predicted target image based on the structure analysis network to determine the at least one first structural feature of the at least one position in the predicted target image, the method further includes: performing image reconstruction processing on the at least one first structural feature based on an image reconstruction network to obtain a first reconstructed image; and determining a first reconstruction loss based on the first reconstructed image and the predicted target image.

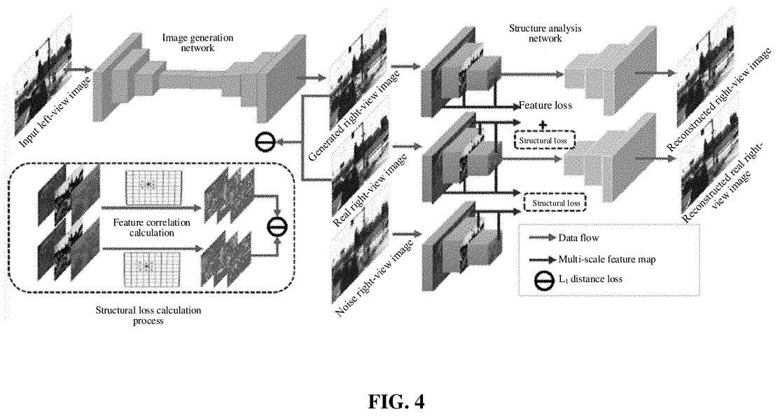

In the present embodiments, in order to improve the performance of the structure analysis network, an image reconstruction network is added after the structure analysis network. Optionally, the image reconstruction network may be connected to the output end of the structure analysis network with reference to FIG. 4.

The image reconstruction network takes the output from the structure analysis network as an input, and reconstructs the image input into the structure analysis network. For example, in the 3D image application scenario shown in FIG. 4, the right-view image (corresponding to the predicted target image in the foregoing embodiments) generated by the image generation network and the real right-view image (corresponding to the second sample image in the foregoing embodiments) are reconstructed to measure the performance of the structure analysis network by means of the difference between the reconstructed generated right-view image and the right-view image generated by the image generation network, and the difference between the reconstructed real right-view image and the real right-view image corresponding to the input left-view image. That is, by increasing the first reconstruction loss and the second reconstruction loss, the performance of the structure analysis network is improved, and the training speed of the structure analysis network is increased.

In one or more optional embodiments, after processing the second sample image based on the structure analysis network to determine the at least one second structural feature of the at least one position in the second sample image, the method further includes: performing image reconstruction processing on the at least one second structural feature based on an image reconstruction network to obtain a second reconstructed image; and determining a second reconstruction loss based on the second reconstructed image and the second sample image.

With reference to the previous embodiments, the image reconstruction network in the present embodiments reconstructs the second structural feature obtained by the structure analysis network based on the second sample image, the performance of the image reconstruction network and the structure analysis network is measured by means of the difference between the obtained second reconstructed image and the second sample image, and the performance of the structure analysis network can be improved through the second reconstruction loss.

As one implementation, the operation of block 240 includes: in a fifth iteration, adjusting the network parameter in the image generation network based on the first structural difference loss, the feature loss, and the color loss; in a sixth iteration, adjusting the network parameter in the structure analysis network based on the first structural difference loss, the second structural difference loss, the first reconstruction loss, and the second reconstruction loss; and obtaining the trained image generation network when the training stopping condition is satisfied.

The fifth iteration and the sixth iteration are two continuously-executed iterations. In the embodiments of the present disclosure, the loss for adjusting the parameter in the image generation network is not changed, and only the performance of the structure analysis network is improved; while the structure analysis network and the image generation network are adversarially trained, and therefore, training of the image generation network can be accelerated by improving the performance of the structure analysis network. In an optional example, the first reconstruction loss and the second reconstruction loss can be obtained by using the following formula (11):

dᵣ(y,y_{g})=∥y−R(c;w_{R})∥₁+∥y_{g}−R(c_{g};w_{R})∥₁ (11)

dᵣ(y,y_{g}) represents a sum of the first reconstruction loss and the second reconstruction loss, y represents the predicted target image output by the image generation network, y_{g} represents the second sample image, R(c;w_{R}) represents the first reconstructed image output by the image reconstruction network, R(c_{g};w_{R}) represents the second reconstructed image output by the image reconstruction network, ∥y−R(c;w_{R})∥₁; represents a distance L₁ between the predicted target image y and the first reconstructed image, corresponding to the first reconstruction loss; and ∥y_{g}−R(c_{g};w_{R})∥₁ represents a distance L₁ between the second sample image and the second reconstructed image, corresponding to the second reconstruction loss.

FIG. 4 is one schematic diagram of a network structure involved in a method for training an image generation network provided in embodiments of the present disclosure. As shown in FIG. 4, in the present embodiments, the input into an image generation network is a left-view image, and the image generation network obtains a generated right-view image (corresponding to the predicted target image in the foregoing embodiments) based on the left-view image; the generated right-view image, and a real right-view image, and a noise image added based on the real right-view image (corresponding to the second sample image in the foregoing embodiments) are input into a same structure analysis network respectively, and the generated right-view image and the real right-view image are processed via the structure analysis network to obtain a feature loss (corresponding to a feature matching loss in the drawing), a first structural difference loss (corresponding to a structural loss in the drawing), a second structural difference loss (corresponding to another structural loss in the drawing); an image reconstruction network is also included after the structure analysis network, and the image reconstruction network reconstructs the features generated by the generated right-view image into a new generated right-view image, and reconstructs the features generated by the real right-view image into a new real right-view image.

In one or more optional embodiments, after the operation of block 140, the method further includes the following step.

A to-be-processed image is processed based on the trained image generation network to obtain a target image.

According to the training method provided in the embodiments of the present disclosure, in specific applications, an input to-be-processed image is processed based on the trained image generation network to obtain a desired target image, where the image generation network may be applied to conversion from a 2D image and video to a 3D stereo image, generation of a video with a high frame rate, etc.; the method further includes: an image at a known view is processed by an image generation network to obtain an image at another view. The generated high-quality right-view image is also useful for other visual tasks, for example, depth estimation is implemented based on a binocular image (including a left-view image and a right-view image). Optionally, when the image generation network is applied to conversion from a 2D image and video to a 3D stereo image, the to-be-processed image includes a left-view image; and the target image includes a right-view image corresponding to the left-view image. In addition to generation of a stereo image, this method may be applied to other image/video generation tasks, for example, generation of content of an image at any new viewpoint, key frame-based video interpolation, etc. In these cases, it is only necessary to replace the image generation network with a network structure required for a target task.

When the training method provided in the embodiments of the present disclosure is applied to a three-dimensional image generation scene, one-time adversarial training of the image generation network and the structure analysis network may include the following steps:

1) sampling a left-view image {x⁽ⁱ⁾}ᵢ₌₁^{m} including m sample images, and its corresponding real right-view image {y_{g}⁽ⁱ⁾}ᵢ₌₁^{m} from a training set (including multiple sample images);

2) inputting the left-view image into the image generation network to obtain a generated right-view image {y⁽⁰⁾}ᵢ₌₁^{m}; for each real right-view image, and adding noise to obtain a noise right-view image {yₙ⁽ⁱ⁾}ᵢ₌₁^{m};

3) inputting the generated right-view image {y⁽⁰⁾}ᵢ₌₁^{m}, the real right-view image {y_{g}⁽ⁱ⁾}ᵢ₌₁^{m}, and the noise right-view image {yₙ⁽ⁱ⁾}ᵢ₌₁^{m} into the structure analysis network respectively to calculate structural expression features {c⁽ⁱ⁾}ᵢ₌₁^{m}, {c_{g}⁽⁰⁾}ᵢ₌₁^{m}, and {cₙ⁽ⁱ⁾}ᵢ₌₁^{m};

4) for the structure analysis network, performing gradient ascent:

$${w}_{A} ← {w}_{A} + γ {∇}_{{w}_{A}} \frac{1}{m} {\sum }_{i = 1}^{m} {L}_{A} ( y , {y}_{g} , {y}_{n} ) ;$$

5) for the image generation network, performing gradient descent:

$${w}_{S} ← {w}_{S} + γ {∇}_{{w}_{S}} \frac{1}{m} {\sum }_{i = 1}^{m} {L}_{A} ( y , {y}_{g} , {y}_{n} ) ;$$

where a decayed learning rate γ can gradually decay with the increase of the number of iterations, and the proportion of a network loss in adjustment of a network parameter is controlled by means of the learning rate; while during obtaining of the noise right-view image, the amplitude of added noise can be the same during each iteration, or as the number of iterations increases, the amplitude of noise gradually decreases.

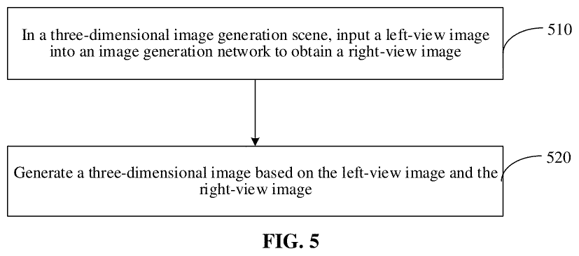

FIG. 5 is a schematic flowchart of a method for image processing provided in embodiments of the present disclosure. The method according to the embodiments includes the following steps.

At block 510, in a three-dimensional image generation scene, a left-view image is input into an image generation network to obtain a right-view image.

At block 520, a three-dimensional image is generated based on the left-view image and the right-view image.

The image generation network is obtained through training by using the method for training an image generation network according to any one of the foregoing embodiments.

According to the method for image processing provided in the embodiments of the present disclosure, the left-view image is processed via the image generation network to obtain a corresponding right-view image, there is a small impact from environmental factors such as lighting, blocking, and noise, so as to maintain the accuracy of synthesis of an object with a relatively small visual area, and a three-dimensional image with relatively small deformation and relatively complete retained details can be generated through obtained right-view image and left-view image. The method for image processing provided in the embodiments of the present disclosure can be applied to automatic conversion from movie 2D to 3D. Manual 3D-movie conversion requires high expenses, a long production cycle, and a lot of labor costs. For example, the conversion of the 3D version of “Titanic” costs up to 18,000,000 US dollars, more than 300 special effect engineers are involved in post-production, and it spends 750,000 hours. An automatic 2D-to-3D algorithm can greatly reduce the costs and speed up a 3D-movie production process. An important factor in generation of a high-quality 3D movie is the need to generate a stereo image with an undistorted and undistorted structure, to create an accurate 3D hierarchical hierarchy, and to avoid visual discomfort caused by local deformation. Therefore, generation of a stereo image with a shape remained is of great significance.

The method for image processing provided in the embodiments of the present disclosure may also be applied to 3D advertising industry. At present, many cities have installed 3D advertising display screens in facilities such as commercial districts, cinemas, and playgrounds. Generating high-quality 3D advertisements can enhance the quality of branding and make customers have a better live experience.

The method for image processing provided in the embodiments of the present disclosure may also be applied to 3D live broadcast industry. Conventional 3D live broadcast requires broadcasters to purchase professional binocular cameras, and this raises the costs and threshold of industry access. High-quality automatic 2D to 3D can lower access costs and increase the liveness and interactivity of the live broadcast.

The method for image processing provided in the embodiments of the present disclosure may also be applied to smart phone industry in the future. At present, mobile phones with a naked eye 3D display function have become hot concepts, and some manufacturers have designed prototypes of concept phones. Captured 2D images are automatically converted into 3D images, and users are allowed to spread and share through social apps, so that mobile terminal-based interactions have a completely new user experience.

A person of ordinary skill in the art may understand that all or some of steps for implementing the foregoing method embodiments are achieved by a program by instructing related hardware; the foregoing program can be stored in a computer-readable storage medium; when the program is executed, steps including the foregoing method embodiments are executed. Moreover, the foregoing storage medium includes various media capable of storing a program code such as a Read-Only Memory (ROM), a Random Access Memory (RAM), a magnetic disk, or an optical disk.

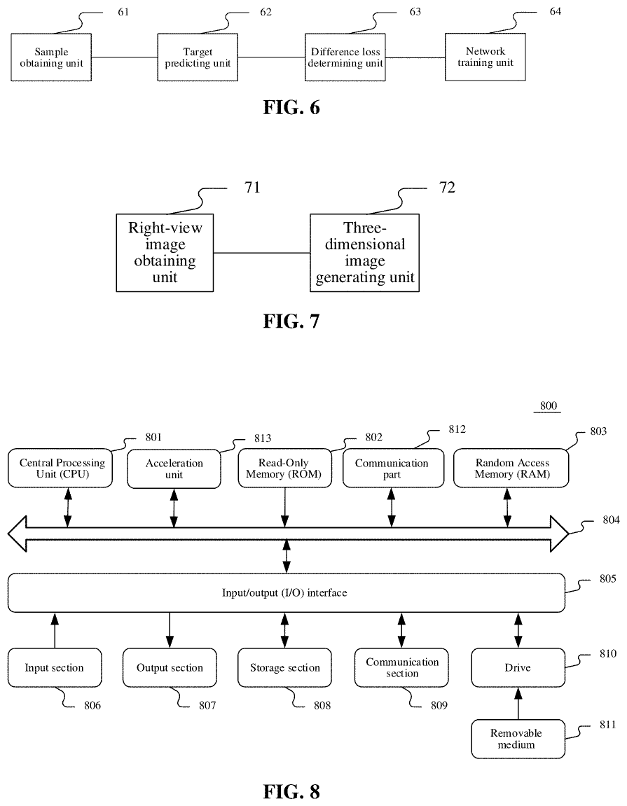

FIG. 6 is a schematic structural diagram of an apparatus for training an image generation network provided in embodiments of the present disclosure. The apparatus according to the embodiments may be configured to implement the foregoing method embodiments of the present disclosure. As shown in FIG. 6, the apparatus according to the embodiments includes: a sample obtaining unit 61, configured to obtain a sample image, where the sample image includes a first sample image and a second sample image corresponding to the first sample image; a target predicting unit 62, configured to process the first sample image based on an image generation network to obtain a predicted target image; a difference loss determining unit 63, configured to determine a difference loss between the predicted target image and the second sample image; and a network training unit 64, configured to train the image generation network based on the difference loss to obtain a trained image generation network.

Based on the apparatus for training an image generation network provided in the foregoing embodiments of the present disclosure, a sample image is obtained, where the sample image includes a first sample image and a second sample image corresponding to the first sample; the first sample image is processed based on an image generation network to obtain a predicted target image; a difference loss between the predicted target image and the second sample image is determined; and the image generation network is trained based on the difference loss to obtain a trained image generation network. A structural difference between the predicted target image and the second sample image is described through the difference loss, and the image generation network is trained based on the difference loss, thereby ensuring an undistorted structure of an image generated based on the image generation network.

In one or more optional embodiments, the difference loss determining unit 63 is specifically configured to determine the difference loss between the predicted target image and the second sample image based on a structure analysis network; and the network training unit 64 is specifically configured to perform adversarial training on the image generation network and the structure analysis network based on the difference loss to obtain the trained image generation network.

As one implementation, during a training phase, adversarial training is performed on the image generation network and the structure analysis network, and the input image passes through the image generation network. For example, during application to 3D image generation, an image at one viewpoint is input to the image generation network to obtain a generated image of this image at another viewpoint. The generated image is input into the same structure analysis network as a real image at this viewpoint, and respective multi-scale feature maps are obtained. On each scale, respective feature correlation expressions are calculated as structural representations on this scale. A training process is performed in an adversarial manner. The structure analysis network is required to continuously enlarge a distance between the structural representations of the generated image and that of the real image. At the same time, the generated image obtained by the image generation network is required to make the distance as small as possible.

As one implementation, the difference loss includes a first structural difference loss and a feature loss.

The difference loss determining unit 63 includes: a first structural difference determining module, configured to process the predicted target image and the second sample image based on the structure analysis network to determine the first structural difference loss between the predicted target image and the second sample image; and a feature loss determining module, configured to determine the feature loss between the predicted target image and the second sample image based on the structure analysis network

As one implementation, the first structural difference determining module is configured to process the predicted target image based on the structure analysis network to determine at least one first structural feature of at least one position in the predicted target image; process the second sample image based on the structure analysis network to determine at least one second structural feature of at least one position in the second sample image; and determine the first structural difference loss between the predicted target image and the second sample image based on the at least one first structural feature and the at least one second structural feature.

As one implementation, when processing the predicted target image based on the structure analysis network to determine the at least one first structural feature of the at least one position in the predicted target image, the first structural difference determining module is configured to process the predicted target image based on the structure analysis network to obtain a first feature map in at least one scale of the predicted target image; and for each first feature map, obtain the at least one first structural feature of the predicted target image based on a cosine distance between a feature of each of at least one position in the first feature map and an adjacent region feature of the position.

Each position in the first feature map corresponds to one first structural feature, and the adjacent region feature is each feature in a region centered on the position and including at least two positions.

As one implementation, when processing the second sample image based on the structure analysis network to determine the at least one second structural feature of the at least one position in the second sample image, the first structural difference determining module is configured to process the second sample image based on the structure analysis network to obtain a second feature map in at least one scale of the second sample image; and for each second feature map, obtain the at least one second structural feature of the second sample image based on a cosine distance between a feature of each of at least one position in the second feature map and an adjacent region feature of the position.

Each position in the second feature map corresponds to one second structural feature.

As one implementation, a correspondence exists between the each position in the first feature map and the each position in the second feature map.

When determining the first structural difference loss between the predicted target image and the second sample image based on the at least one first structural feature and the at least one second structural feature, the first structural difference determining module is configured to calculate a distance between the first structural feature and the second structural feature corresponding to positions where the correspondence exists; and determine the first structural difference loss between the predicted target image and the second sample image based on distances between all first structural features and second structural features corresponding to the predicted target image.

As one implementation, the feature loss determining module is specifically configured to process the predicted target image and the second sample image based on the structure analysis network to obtain the first feature map in the at least one scale of the predicted target image and the second feature map in the at least one scale of the second sample image; and determine the feature loss between the predicted target image and the second sample image based on at least one first feature map and at least one second feature map.

As one implementation, the correspondence exists between the each position in the first feature map and the each position in the second feature map.

When determining the feature loss between the predicted target image and the second sample image based on the at least one first feature map and the at least one second feature map, the feature loss determining module is configured to calculate a distance between a feature in the first feature map and a feature in the second feature map corresponding to the positions where the correspondence exists; and determine the feature loss between the predicted target image and the second sample image based on the feature in the first feature map and the feature in the second feature map.

As one implementation, the difference loss further includes a color loss.

The difference loss determining unit 63 further includes: a color loss determining module, configured to determine a color loss of the image generation network based on the color loss between the predicted target image and the second sample image; the network training unit 64 is specifically configured to, in a first iteration, adjust a network parameter in the image generation network based on the first structural difference loss, the feature loss, and the color loss; in a second iteration, adjust the network parameter in the structure analysis network based on the first structural difference loss; and obtain a trained image generation network when a training stopping condition is satisfied.

The first iteration and the second iteration are two continuously-executed iterations. The purpose of the adversarial training is to reduce a difference between the predicted target image obtained by the image generation network and the second sample image. The adversarial training is usually implemented by means of alternating training. In the embodiments of the present disclosure, the image generation network and the structure analysis network are alternately trained to obtain an image generation network that satisfies requirements.

In one or more optional embodiments, the apparatus provided in the embodiments of the present disclosure further includes: a noise adding unit, configured to add noise to the second sample image to obtain a noise image; and a second structural difference loss unit, configured to determine a second structural difference loss based on the noise image and the second sample image.

Because the predicted target image is generated from the sample image, while the second sample image usually has a lighting difference and will be affected by noise, resulting in a certain distribution difference between the generated predicted target image and the second sample image. In order to prevent the structure analysis network from paying attention to these differences, rather than scene structure information, in the embodiments of the present disclosure, a resistance mechanism to noise is added during the training process.

As one implementation, the second structural difference loss unit is specifically configured to process the noise image based on the structure analysis network to determine at least one third structural feature of at least one position in the noise image; process the second sample image based on the structure analysis network to determine the at least one second structural feature of the at least one position in the second sample image; and determine the second structural difference loss between the noise image and the second sample image based on the at least one third structural feature and the at least one second structural feature.

As one implementation, when processing the noise image based on the structure analysis network to determine the at least one third structural feature of the at least one position in the noise image, the second structural difference loss unit is configured to process the noise image based on the structure analysis network to obtain a third feature map in at least one scale of the noise image; and for each third feature map, obtain the at least one third structural feature of the noise image based on a cosine distance between a feature of each of at least one position in the third feature map and an adjacent region feature of the position, where each position in the third feature map corresponds to one third structural feature, and the adjacent region feature is each feature in a region centered on the position and including at least two positions.

As one implementation, a correspondence exists between the each position in the third feature map and the each position in the second feature map.

When determining the second structural difference loss between the noise image and the second sample image based on the at least one third structural feature and the at least one second structural feature, the second structural difference loss unit is configured to calculate a distance between the third structural feature and the second structural feature corresponding to positions where the correspondence exists; and determine the second structural difference loss between the noise image and the second sample image based on distances between all third structural features and second structural features corresponding to the noise image.

As one implementation, the network training unit is specifically configured to, in a third iteration, adjust the network parameter in the image generation network based on the first structural difference loss, the feature loss, and the color loss; in a fourth iteration, adjust the network parameter in the structure analysis network based on the first structural difference loss and the second structural difference loss; and obtain the trained image generation network when the training stopping condition is satisfied. The third iteration and the fourth iteration are two continuously-executed iterations.

As one implementation, the first structural difference determining module is further configured to perform image reconstruction processing on the at least one first structural feature based on an image reconstruction network to obtain a first reconstructed image; and determine a first reconstruction loss based on the first reconstructed image and the predicted target image.

As one implementation, the first structural difference determining module is further configured to perform image reconstruction processing on the at least one second structural feature based on an image reconstruction network to obtain a second reconstructed image; and determine a second reconstruction loss based on the second reconstructed image and the second sample image.

As one implementation, the network training unit is specifically configured to, in a fifth iteration, adjust the network parameter in the image generation network based on the first structural difference loss, the feature loss, and the color loss; in a sixth iteration, adjust the network parameter in the structure analysis network based on the first structural difference loss, the second structural difference loss, the first reconstruction loss, and the second reconstruction loss; and obtain the trained image generation network when the training stopping condition is satisfied. The fifth iteration and the sixth iteration are two continuously-executed iterations.

In one or more optional embodiments, the apparatus provided in the embodiments of the present disclosure further includes: an image processing unit, configured to process a to-be-processed image based on the trained image generation network to obtain a target image.

According to the training apparatus provided in the embodiments of the present disclosure, in specific applications, an input to-be-processed image is processed based on the trained image generation network to obtain a desired target image, where the image generation network may be applied to conversion from a 2D image and video to a 3D stereo image, generation of a video with a high frame rate, etc.

As one implementation, the to-be-processed image includes a left-view image; and the target image includes a right-view image corresponding to the left-view image.

FIG. 7 is a schematic structural diagram of an apparatus for image processing provided in embodiments of the present disclosure. The apparatus according to the embodiments includes: a right-view image obtaining unit 71, configured to, in a three-dimensional image generation scene, input a left-view image into an image generation network to obtain a right-view image; and a three-dimensional image generating unit 72, configured to generate a three-dimensional image based on the left-view image and the right-view image.

The image generation network is obtained through training by using the method for training an image generation network according to any one of the foregoing embodiments.

According to the apparatus for image processing provided in the embodiments of the present disclosure, the left-view image is processed via the image generation network to obtain a corresponding right-view image, there is a small impact from environmental factors such as lighting, blocking, and noise, so as to maintain the accuracy of synthesis of an object with a relatively small visual area, and a three-dimensional image with relatively small deformation and relatively complete retained details can be generated through obtained right-view image and left-view image.

The embodiments of the present disclosure provide an electronic device, including a processor, where the processor includes the apparatus for training an image generation network according to any one of the foregoing embodiments or the apparatus for image processing according to the foregoing embodiments.

The embodiments of the present disclosure provide an electronic device, including: a processor, and a memory configured to store processor-executable instructions, where the processor is configured to implement the method for training an image generation network and/or the method for image processing according to any one of the foregoing embodiments by executing the executable instructions.

The embodiments of the present disclosure provide a computer storage medium, configured to store computer-readable instructions, where when the readable instructions are executed, operations of the method for training an image generation network according to any one of the foregoing embodiments are performed, and/or operations of the method for image processing according to the foregoing embodiments are performed.

The embodiments of the present disclosure provide a computer-readable product, including a computer-readable code, where when the computer-readable code runs in a device, a processor in the device executes instructions for implementing the method for generating an image generation network according to any one of the foregoing embodiments, and/or executes instructions for implementing the method for image processing according to the foregoing embodiments.

The embodiments of the present disclosure further provide an electronic device, which, for example, may be a mobile terminal, a Personal Computer (PC), a tablet computer, a server, or the like. Referring to FIG. 8 below, FIG. 8 shows a schematic structural diagram of an electronic device 800 suitable for implementing a terminal device or a server according to the embodiments of the present disclosure. As shown in FIG. 8, the electronic device 800 includes one or more processors, a communication part, and the like; the one or more processors are, for example, one or more Central Processing Units (CPUs) 801 and one or more special-purpose processors; the special-purpose processor may be used as an acceleration unit 813, and may include, but may be not limited to, a special-purpose processor such as a Graphics Processing Unit (GPU), a Field-Programmable Gate Array (FPGA), a Digital Signal Processor (DSP), and another Application-Specific Integrated Circuit (ASIC) chip; the processor may perform various appropriate actions and processing according to executable instructions stored in an ROM 802 or executable instructions loaded from a storage section 808 into an RAM 803. The communication part 812 may include, but may be not limited to, a network card. The network card may include, but may be not limited to, an Infiniband (IB) network card.

The processor may communicate with the ROM 802 and/or the RAM 803 to execute the executable instructions, is connected to the communication part 812 via a bus 804, and communicates with other target devices by means of the communication part 812, so as to complete corresponding operations of any method provided in the embodiments of the present disclosure, for example, a sample image is obtained, where the sample image includes a first sample image and a second sample image corresponding to the first sample; the first sample image is processed based on an image generation network to obtain a predicted target image; a difference loss between the predicted target image and the second sample image is determined; and the image generation network is trained based on the difference loss to obtain a trained image generation network.

In addition, the RAM 803 may further store various programs and data required for operations of the apparatuses. The CPU 801, the ROM 802, and the RAM 803 are connected to each other via the bus 804. In the presence of the RAM 803, the ROM 802 is an optional module. The RAM 803 stores the executable instructions, or writes the executable instructions into the ROM 802 during running, where the executable instructions cause the CPU 801 to execute corresponding operations of the foregoing communication method. An Input/Output (I/O) interface 805 is also connected to the bus 804. The communication part 812 may be integrated, or may be configured to have multiple sub-modules (for example, multiple IB network cards) connected to the bus.

The following components are connected to the I/O interface 805: an input section 806 including a keyboard, a mouse, or the like; an output section 807 including a Cathode-Ray Tube (CRT), a Liquid Crystal Display (LCD), a speaker, or the like; the storage section 808 including a hard disk or the like; and a communication part 809 of a network interface card including an LAN card, a modem, or the like. The communication section 809 performs communication processing via a network such as the Internet. A drive 810 is also connected to the I/O interface 805 according to requirements. A removable medium 811 such as a disk, an optical disk, a photo-magnetic disk, and a semiconductor memory is installed on the drive 810 according to requirements, to cause a computer program read from the removable medium 808 to be installed into the storage part 808 according to requirements.

It should be noted that, the architecture shown in FIG. 8 is merely an optional implementation. During specific practice, the number and types of the components in FIG. 8 may be selected, decreased, increased, or replaced according to actual requirements. Different functional components may be separated or integrated or the like. For example, the acceleration unit 813 and the CPU 801 may be separated, or the acceleration unit 813 may be integrated on the CPU 801, and the communication part may be separated from or integrated on the CPU 801 or the acceleration unit 813 or the like. These alternative implementations all fall within the scope of protection of the present disclosure.

According to the embodiments of the present disclosure, the process described above with reference to the flowchart may be implemented as a computer software program. For example, the embodiments of the present disclosure include a computer program product. The computer program product includes a computer program tangibly included in a machine-readable medium. The computer program includes a program code for executing a method shown in the flowchart. The program code may include instructions for performing steps of the method provided in the embodiments of the present disclosure, for example, a sample image is obtained, where the sample image includes a first sample image and a second sample image corresponding to the first sample; the first sample image is processed based on an image generation network to obtain a predicted target image; a difference loss between the predicted target image and the second sample image is determined; and the image generation network is trained based on the difference loss to obtain a trained image generation network. In such embodiments, the computer program may be downloaded and installed from the network through the communication section 809, and/or installed from the removable medium 811. The computer program, when being executed by the CPU 801, executes operations of the foregoing functions defined in the methods of the present disclosure.

The methods and apparatuses in the present disclosure may be implemented in many manners. For example, the methods and devices in the present disclosure may be implemented with software, hardware, firmware, or any combination of software, hardware, and firmware. The foregoing specific sequence of steps of the method is merely for description, and unless otherwise stated particularly, is not intended to limit the steps of the method in the present disclosure. In addition, in some embodiments, the present disclosure is also implemented as programs recorded in a recording medium. The programs include machine-readable instructions for implementing the methods according to the present disclosure. Therefore, the present disclosure further covers the recording medium storing the programs for performing the methods according to the present disclosure.

The descriptions of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to make a person of ordinary skill in the art understand the present disclosure, so as to design various embodiments with various modifications applicable to particular use.

### INDUSTRIAL APPLICABILITY

According to the technical solutions of the embodiments of the present disclosure, a sample image is obtained, where the sample image includes a first sample image and a second sample image corresponding to the first sample; the first sample image is processed based on an image generation network to obtain a predicted target image; a difference loss between the predicted target image and the second sample image is determined; and the image generation network is trained based on the difference loss to obtain a trained image generation network. Thus, a structural difference between the predicted target image and the second sample image is described through the difference loss, and the image generation network is trained based on the difference loss, thereby ensuring an undistorted structure of an image generated based on the image generation network.

1. A method for training an image generation network, comprising:
obtaining a sample image, wherein the sample image comprises a first sample image and a second sample image corresponding to the first sample image;
processing the first sample image based on an image generation network to obtain a predicted target image;
determining a difference loss between the predicted target image and the second sample image; and
training the image generation network based on the difference loss to obtain a trained image generation network.

2. The method according to claim 1, wherein determining the difference loss between the predicted target image and the second sample image comprises:
determining the difference loss between the predicted target image and the second sample image based on a structure analysis network; and
training the image generation network based on the difference loss to obtain the trained image generation network comprises:
performing adversarial training on the image generation network and the structure analysis network based on the difference loss to obtain the trained image generation network.

3. The method according to claim 2, wherein the difference loss comprises a first structural difference loss and a feature loss;
determining the difference loss between the predicted target image and the second sample image comprises:
processing the predicted target image and the second sample image based on the structure analysis network to determine the first structural difference loss between the predicted target image and the second sample image; and
determining the feature loss between the predicted target image and the second sample image based on the structure analysis network.

4. The method according to claim 3, wherein processing the predicted target image and the second sample image based on the structure analysis network to determine the first structural difference loss between the predicted target image and the second sample image comprises:
processing the predicted target image based on the structure analysis network to determine at least one first structural feature of at least one position in the predicted target image;
processing the second sample image based on the structure analysis network to determine at least one second structural feature of at least one position in the second sample image; and
determining the first structural difference loss between the predicted target image and the second sample image based on the at least one first structural feature and the at least one second structural feature.

5. The method according to claim 4, wherein processing the predicted target image based on the structure analysis network to determine the at least one first structural feature of the at least one position in the predicted target image comprises:
processing the predicted target image based on the structure analysis network to obtain at least one first feature map in at least one scale of the predicted target image; and
obtaining, for each of the at least one first feature map, the at least one first structural feature of the predicted target image based on a cosine distance between a feature of each of at least one position in the first feature map and a feature of an adjacent region to the position, wherein each position in the first feature map corresponds to one first structural feature, and the feature of the adjacent region is each feature in a region centered on the position and comprising at least two positions.

6. The method according to claim 4, wherein processing the second sample image based on the structure analysis network to determine the at least one second structural feature of the at least one position in the second sample image comprises:
processing the second sample image based on the structure analysis network to obtain at least one second feature map in at least one scale of the second sample image; and
obtaining, for each of the at least one second feature map, the at least one second structural feature of the second sample image based on a cosine distance between a feature of each of at least one position in the second feature map and a feature of an adjacent region to the position, wherein each position in the second feature map corresponds to one second structural feature.

7. The method according to claim 6, wherein the each position in the first feature map has a correspondence with the each position in the second feature map;
wherein determining the first structural difference loss between the predicted target image and the second sample image based on the at least one first structural feature and the at least one second structural feature comprises:
calculating a distance between the first structural feature corresponding to a position in the first feature map and the second structural feature corresponding to a position in the second feature map having a correspondence to the position, in the first feature map; and
determining the first structural difference loss between the predicted target image and the second sample image based on distances between all first structural features and second structural features corresponding to the predicted target image.

8. The method according to claim 3, wherein determining the feature loss between the predicted target image and the second sample image based on the structure analysis network comprises:
processing the predicted target image and the second sample image based on the structure analysis network to obtain the first feature map in the at least one scale of the predicted target image and the second feature map in the at least one scale of the second sample image; and
determining the feature loss between the predicted target image and the second sample image based on at least one first feature map and at least one second feature map.

9. The method according to claim 8, wherein each position in the first feature map has a correspondence with each position in the second feature map;
determining the feature loss between the predicted target image and the second sample image based on the at least one first feature map and the at least one second feature map comprises:
calculating a distance between a feature in the first feature map and a feature in the second feature map respectively corresponding to the positions having a correspondence; and
determining the feature loss between the predicted target image and the second sample image based on the feature in the first feature map and the feature in the second feature map.

10. The method according to claim 3, wherein the difference loss further comprises a color loss; and before training the image generation network based on the difference loss to obtain the trained image generation network, the method further comprises:
determining a color loss of the image generation network based on the color loss between the predicted target image and the second sample image;
wherein performing the adversarial training on the image generation network and the structure analysis network based on the difference loss to obtain the trained image generation network comprises:
adjusting, in a first iteration, a network parameter in the image generation network based on the first structural difference loss, the feature loss, and the color loss;
adjusting, in a second iteration, the network parameter in the structure analysis network based on the first structural difference loss, wherein the first iteration and the second iteration are two continuously-executed iterations; and
obtaining the trained image generation network when a training stopping condition is satisfied.

11. The method according to claim 1, wherein before determining the difference loss between the predicted target image and the second sample image, the method further comprises:
adding noise to the second sample image to obtain a noise image; and
determining a second structural difference loss based on the noise image and the second sample image.

12. The method according to claim 11, wherein determining the second structural difference loss based on the noise image and the second sample image comprises:
processing the noise image based on the structure analysis network to determine at least one third structural feature of at least one position in the noise image;
processing the second sample image based on the structure analysis network to determine the at least one second structural feature of the at least one position in the second sample image; and
determining the second structural difference loss between the noise image and the second sample image based on the at least one third structural feature and the at least one second structural feature.

13. The method according to claim 12, wherein processing the noise image based on the structure analysis network to determine the at least one third structural feature of the at least one position in the noise image comprises:
processing the noise image based on the structure analysis network to obtain at least one third feature map in at least one scale of the noise image; and
obtaining, for each of the at least one third feature map, the at least one third structural feature of the noise image based on a cosine distance between a feature of each of at least one position in the third feature map and a feature of an adjacent region to the position, wherein each position in the third feature map corresponds to one third structural feature, and the adjacent region feature is each feature in a region centered on the position and comprising at least two positions.

14. The method according to claim 12, wherein the each position in the third feature map has a correspondence with the each position in the second feature map;
wherein determining the second structural difference loss between the noise image and the second sample image based on the at least one third structural feature and the at least one second structural feature comprises:
calculating a distance between the third structural feature and the second structural feature respectively corresponding to positions having a correspondence; and
determining the second structural difference loss between the noise image and the second sample image based on distances between all third structural features and second structural features corresponding to the noise image.

15. The method according to claim 11, wherein performing the adversarial training on the image generation network and the structure analysis network based on the difference loss to obtain the trained image generation network comprises:
adjusting, in a third iteration, the network parameter in the image generation network based on the first structural difference loss, the feature loss, and the color loss;
adjusting, in a fourth iteration, the network parameter in the structure analysis network based on the first structural difference loss and the second structural difference loss, wherein the third iteration and the fourth iteration are two continuously-executed iterations; and
obtaining the trained image generation network when the training stopping condition is satisfied.

16. The method according to claim 4, wherein after processing the predicted target image based on the structure analysis network to determine the at least one first structural feature of the at least one position in the predicted target image, the method further comprises:
performing image reconstruction processing on the at least one first structural feature based on an image reconstruction network to obtain a first reconstructed image; and
determining a first reconstruction loss based on the first reconstructed image and the predicted target image.

17. The method according to claim 16, wherein after processing the second sample image based on the structure analysis network to determine the at least one second structural feature of the at least one position in the second sample image, the method further comprises:
performing image reconstruction processing on the at least one second structural feature based on an image reconstruction network to obtain a second reconstructed image; and
determining a second reconstruction loss based on the second reconstructed image and the second sample image.

18. The method according to claim 17, wherein performing the adversarial training on the image generation network and the structure analysis network based on the difference loss to obtain the trained image generation network comprises:
adjusting, in a fifth iteration, the network parameter in the image generation network based on the first structural difference loss, the feature loss, and the color loss;
adjusting, in a sixth iteration, the network parameter in the structure analysis network based on the first structural difference loss, the second structural difference loss, the first reconstruction loss, and the second reconstruction loss, wherein the fifth iteration and the sixth iteration are two continuously-executed iterations; and
obtaining the trained image generation network when the training stopping condition is satisfied.

19. An electronic device, comprising:
a processor, and
a memory configured to store processor-executable instructions,
wherein the processor is configured to:
obtain a sample image, wherein the sample image comprises a first sample image and a second sample image corresponding to the first sample image;
process the first sample image based on an image generation network to obtain a predicted target image;
determine a difference loss between the predicted target image and the second sample image; and
train the image generation network based on the difference loss to obtain a trained image generation network.

20. A non-transitory computer storage medium, having computer-readable instructions stored therein, wherein the instructions, when being executed, cause to perform operations of the method for training an image generation network, comprising:
obtaining a sample image, wherein the sample image comprises a first sample image and a second sample image corresponding to the first sample image;
processing the first sample image based on an image generation network to obtain a predicted target image;
determining a difference loss between the predicted target image and the second sample image; and
training the image generation network based on the difference loss to obtain a trained image generation network.
